(19) United States
(12) Patent Application Publication
(10) Pub. No.: US 2026/0236574 A1
(43) Pub. Date: Aug. 13, 2026

(54) MANAGING CANARY FILES IN A FILESYSTEM

(71) Applicant: International Business Machines Corporation, Armonk, NY (US)

(72) Inventors: Sasikanth Eda, Vijayawada (IN); Sandeep Ramesh Patil, Pune (IN); Yu-Cheng Hsu, Tucson, AZ (US); Sridhar Muppidi, Austin, TX (US)

(21) Appl. No.: 19/645,370

(22) Filed: Apr. 13, 2026

Related U.S. Application Data
(63) Continuation of application No. 18/319,783, filed on May 18, 2023.

(51) Int. Cl. G06F 21/55; G06F 21/57

(52) U.S. Cl. CPC G06F 21/552; G06F 21/577; G06F 2221/034

(57) ABSTRACT

Described are techniques for managing canary files in a filesystem. The techniques include identifying an attack surface of the filesystem based on monitored filesystem activity data. The techniques further include generating hot spot maps based on the identified attach surface and identifying filesystem locations associated with elevated rates of change. The techniques further include splitting a file associated with a hot spot into logical sections and monitoring activity data associated with the logical sections. The techniques further include generating one or more canary files by assembling file content from logical sections identified as least-important and placing the one or more canary files within a directory corresponding to the hot spot.

### BACKGROUND

The subject matter disclosed herein relates to data security and more particularly relates to canary file maintenance.

A canary file is a fake computer document that is placed amongst real documents to aid in the early detection of unauthorized data access, copying, or modification.

### SUMMARY

Aspects of the present disclosure are directed toward a computer-implemented method comprising monitoring filesystem activity data associated with accessing files in a filesystem to identify an attack surface of the filesystem based on the monitored filesystem activity data. The computer-implemented method further comprising collecting filesystem journal data and generating, from the filesystem journal data, hot spot maps identifying filesystem locations associated with elevated rates of change. For a file associated with a hot spot identified in the hot spot maps, the computer-implemented method further comprises splitting the file into logical sections; monitoring, for each logical section, activity data for the logical section to determine at least one selected from a group consisting of: an access frequency value for the logical section and a data importance value of the logical section; and storing in one or more data structures, for each logical section, at least one selected from the group consisting of: the access frequency value and the data importance value. The computer-implemented method further comprising selecting a least-important logical section of the file based on at least one selected from the group consisting of: the stored access frequency value and the stored data importance value. The computer-implemented method further comprising generating one or more canary files by assembling file content from the selected least-important logical section and assigning metadata to the one or more canary files that emulates metadata of files in the hot spot. The computer-implemented method further comprising storing the one or more canary files within a directory corresponding to the hot spot.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an enterprise filesystem global namespace system in accordance with one embodiment of the present invention;

FIG. 2 is a block diagram illustrating one example of a computing stack in accordance with at least one embodiment disclosed herein;

FIG. 3 is a schematic flow chart diagram illustrating one embodiment of a method for performing canary file management in accordance with one embodiment of the present invention;

FIG. 4 is a schematic flow chart diagram illustrating one embodiment of a method for performing canary file management in accordance with one embodiment of the present invention; and

FIG. 5 is a schematic flow chart diagram illustrating one embodiment of a method for performing canary file management in accordance with one embodiment of the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present invention may be an apparatus, a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatuses, systems, and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

The flowchart and block diagrams in the figures illustrate the architecture, functionality, and operation of possible implementations of apparatuses, systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of elements in each figure may refer to elements of proceeding figures. Like numbers refer to like elements in all figures, including alternate embodiments of like elements.

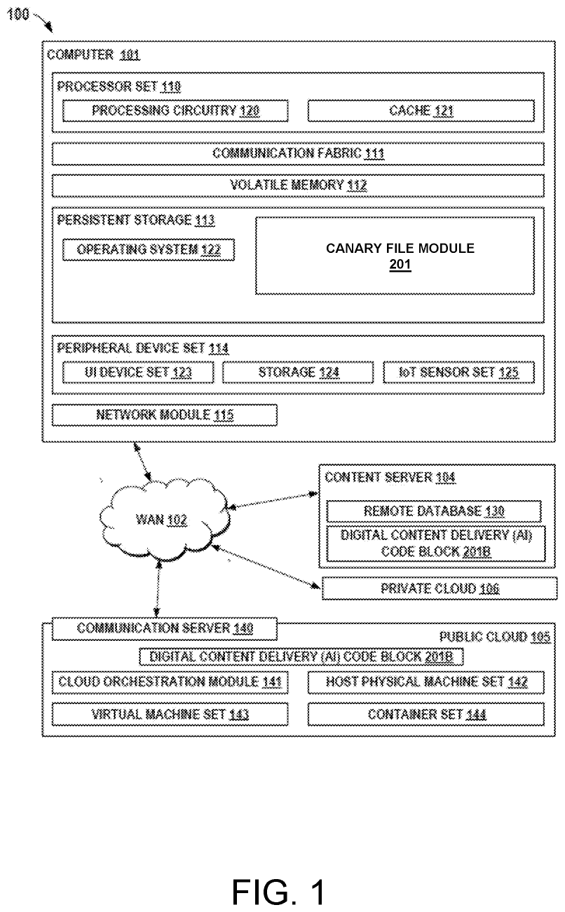

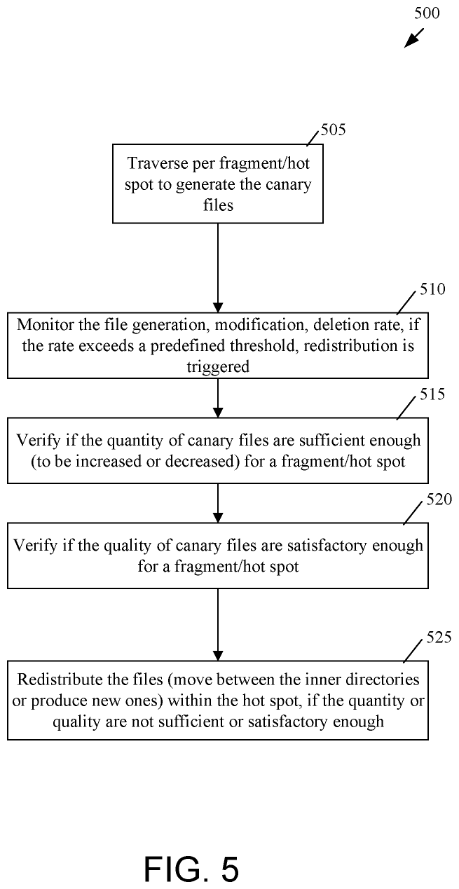

FIG. 1 is a block diagram illustrating various portions of a computing environment 100 in accordance with at least one embodiment disclosed herein. Computing environment 100 contains an example of an environment for the execution of at least some of the computer code involved in performing the inventive methods or processes, such as code block/canary file module 201 (corresponding to the method 500 shown in FIG. 5). In some embodiments, portions of the canary file module 201 reside within the operating system 122. In addition to the canary file module 201, computing environment 100 includes, for example, computer 101, wide area network (WAN) 102, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the canary file module 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented process, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the canary file module 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open source Portable Operating System Interface-type operating systems that employ a kernel. The code included in the canary file module 201 typically includes at least some of the computer code involved in performing the inventive methods such as identifying data errors.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Canary files may be generated using content and file statistics drawn from three sources: (1) Internet harvested documents; (2) documents collected from across the entire enterprise environment (i.e., dynamically pulls random data from a random directory); and (3) documents within the specific target directory (i.e., dynamically pulls random data from a specified single directory). Each data source is allocated a weighting based on the strength of its relationship to the target directory. The weighting is seeded with a random value to avoid discovery by simple statistical-based fake file detection systems.

Traditional canary generation methods help generate canary files (quantity) and help place them in the directory structure. But enterprise filesystem global namespaces are usually built using mixed disk types. A global namespace is a federation of file systems from any number of file storage devices, such as servers using NFS (network file system), CIFS (common Internet file system), NAS (network-attached storage), or file servers. Enterprises and large institutions often manage complex document workflow between multiple locations. Cloud Storage offers the advantage of a convenient central location for data storage but lacks file system options for securely sharing files and their metadata. In other words, it's important for a file that is opened and modified in one location to be immediately available in a different location once the file is closed. Another challenge occurs when a user edits a file in one city, thereby denying access to others trying to work on the same file. BridgeSTOR® resolves these issues with file versioning and soft file deletion, allowing each change to be saved independently. Each disk type is accumulated to a storage pool (i.e., all serial advanced technology attachment (SATA) disks are combined as a “bronze” pool, serial-attachment SCSI (small computer system interface) disks are combined as “silver pool,” and solid state drive (SSD) disks are combined as “gold pool”, etc.) and tiering policies are applied for seamless movement of data between the tiers (i.e. filesystem monitors the file heat, migrates the files with low heat to cold tier/bronze tier in this scenario, and migrates the files with higher heat to hot tier/gold tier). In this kind of model, canary files that are placed in the different directory structures of the namespace will soon lose their file heat, since these files will not be accessed by normal/non-malicious users and that reduces its file heat in relative comparison with the other files in the namespace and will be moved to the cold tier. Thereby, all cold tier/SATA disks are filled by the canary files, which could defeat the purpose of storage pools and causes uneven distribution on disks. This increases a carbon footprint, as more and more canary files are migrated to hard disk drive (HDD) tier and HDDs consume more power than SSD's due to spindle/mechanical movements.

The canary file module 201 embodied as code stored in non-transitory computer-readable medium causes the computer 101 to maintain an even balance of canary files. The file heat of the canary files is adjusted by a global namespace. The canary file module 201 cause the computer 101 to generate canary files that dynamically readjust/maintain their file heat and provide an enhancement to information life cycle management (ILM) tool chain in order to remain distributed from the storage perspective as well as uniformly distribute/readjust the quantity of the canary files within a directory tree. Canary files are usually embedded with a trigger to external consumer, which is usually a small size, but in order to mimic them as other application files, their size is bloated by some random content where the generation of this random content consumes more CPU cycles and could result in degradation of system performance.

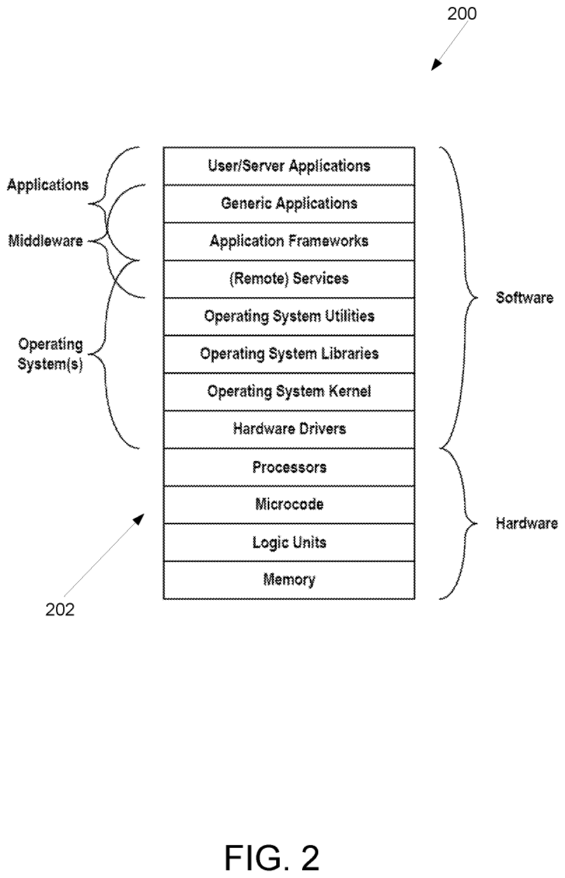

FIG. 2 is a block diagram illustrating one example of a computing stack 200 in accordance with at least one embodiment disclosed herein. As depicted, the computing stack 200 includes a number of computing layers 202 used for conducting computing operations. In the depicted embodiment, the layers include hardware layers and software layers. The various software layers include operating system layers associated with executing one or more operating systems, middleware layers associated with executing middleware that expands and/or improves the functionality of hardware layers and executing operating system(s). The software layers may also include various application-specific layers. The application-specific layers may include application frameworks that further expand on, and/or improve upon, the functionality of hardware layers and operating system layers.

The memory layer may include volatile memory, non-volatile memory, persistent storage, and hardware associated with controlling such memory. The logic units may include CPUs, arithmetic units, graphic processing units, and hardware associated with controlling such units. The microcode layer may include executable instructions for controlling the processing flow associated with moving data between memory and the logic units. The processor layer may include instruction fetch units, instruction decode units, and the like that enable execution of processing instructions and utilization of the underlying hardware layers.

The hardware drivers (also known as the hardware abstraction layer) may include executable code that enables an operating system to access and control storage devices, DMA hardware, I/O buses, peripheral devices, and other hardware associated with a computing environment. The operating system kernel layer may receive I/O requests from higher layers and manage memory and other hardware resources via the hardware drivers. The operating system kernel layer may also provide other functions such as inter-process communication and file management.

Operating system libraries and utilities may expand the functionality provided by the operating system kernel and provide an interface for accessing those functions. Libraries are typically leveraged by higher layers of software by linking library object code into higher level software executables. In contrast, operating system utilities are typically standalone executables that can be invoked via an operating system shell that receives commands from a user and/or a script file. Examples of operating system libraries include file I/O libraries, math libraries, memory management libraries, process control libraries, data access libraries, and the like. Examples of operating system utilities include anti-virus managers, disk formatters, disk defragmenters, file compressors, data or file sorters, data archivers, memory testers, program installers, package managers, network utilities, system monitors, system profilers, and the like.

Services are often provided by a running executable or process that receives local or remote requests from other processes or devices called clients. A computer running a service is often referred to as a server. Examples of servers include database servers, file servers, mail servers, print servers, web servers, game servers, and application servers.

Application frameworks provide functionality that is commonly needed by applications and include system infrastructure frameworks, middleware integration, frameworks, enterprise application frameworks, graphical rendering frameworks, and gaming frameworks. An application framework may support application development for a specific environment or industry. In some cases, application frameworks are available for multiple operating systems and providing a common programming interface to developers across multiple platforms.

Generic applications include applications that are needed by most users. Examples of generic applications include mail applications, calendaring and scheduling applications, and web browsers. Such applications may be automatically included with an operating system.

One of skill in the art will appreciate that an improvement to any of the depicted layers, or similar layers that are not depicted herein, results in an improvement to the computer itself including the computer 101 and/or the end user devices 103. One of skill in the art will also appreciate that the depicted layers are given by way of example are not representative of all computing devices. Nevertheless, the concept of improving the computer itself by improving one or more functional layers is essentially universal.

The executables and programs described herein are identified based upon the application or software layer for which they are implemented in a specific embodiment of the present invention. However, it should be appreciated that any particular program nomenclature herein is used merely for convenience, and thus the present invention should not be limited to use solely in any specific identified application or software layer.

In various embodiments, the canary file module 201 causes the computer 101 to perform real-time or estimated calculation of attack surface (velocity, volume, variety). The attack surface is a set of points on the boundary of a system, a system component, or an environment where an attacker can try to enter, cause an effect on, or extract data from that system, component, or environment. The measure (velocity, volume, variety) of the attack surface plays an important role in determining the quantities and distribution width/ratio for the canary files placement.

In various embodiments, the canary file module 201 causes the computer 101 to determine a real time measure of attack surfaces based on the number of protocols (e.g., rate of input/output (I/O) requests, I/O request types (such as data only, metadata only or both, etc.), ratio of authentication success/denial requests, or comparable protocols).

In various embodiments, the canary file module 201 causes the computer 101 to obtain an attack surface analysis via workflows built in existing products, such as CrowdStrike®, Randori, and the like.

In various embodiments, the canary file module 201 causes the computer 101 to generate estimation calculations of attack surfaces using threat models prepared during the solution phase. Threat vectors defined in the threat models are used to approximate the weight/impact that can be caused by an attack.

In various embodiments, the canary file module 201 causes the computer 101 to measure the heat of the targeted filesystem layout structure. The canary file module 201 causes the computer 101 to obtain micro-fragmented hot spot maps from storage perspective based on rate of changes happening in filesystem journals. The filesystem journals are viewed per fragmented section that could be a directory. The micro-fragmented hot spot maps may be obtained using a number of flushes happening per logically marked segments or the like.

In various embodiments, the canary file module 201 causes the computer 101 to predict amount of data change rate of standard migration between storage tiers. Migration rate is the quantity of files that migrate across the storage tiers in a specified period. The migration rate can be predicted based on calculating an average amount of data transferred across the tiers by normalizing the access time from the historical data, reclaiming storage space in the storage tiers during a particular duration, or providing configured policy that performs weighted approximation of file heat loss rate based on the access rate.

Also, the canary file module 201 has the ability to measure heat per logical section defined per file. Traditional filesystems track file heat (in relative terms). In various embodiments, the canary file module 201 causes the computer 101 to split a canary file into a pre-defined logical section and track the heat per section.

In various embodiments, the canary file module 201 causes the computer 101 to measure importance of data and rank the data based on the logical section defined per file. Traditional filesystems track file access time and their frequency (which denotes the importance). In various embodiments, the canary file is split into a pre-defined logical section and the access rate is tracked along with the I/O type that occurred, deduplication pointers, or other metadata information per section to determine the importance of data.

In various embodiments, the canary file module 201 causes the computer 101 to track access frequency (i.e., heat) per logical section (the size of logical section is user configurable) and is implemented via tables or data structures that can be stored in databases/files or in memory.

In various embodiments, the canary file module 201 causes the computer 101 to generate canary files to perform dynamic readjusting/maintaining of their file heat. Once a hot spot map is identified, canary files within each spot are generated based on the following factors for aiding in the below ILM changes:
Least important data section of both hot file and cold file are used to create the contents of the canary file;
Emulation of canary file metadata depends on the least importance pieces of blocks/sections within the storage tiers; and
Thumbnails of canary file content will be in close combination of cold and hot data.

In various embodiments, the canary file module 201 causes the computer 101 to enhance the ILM tool chain in order to remain canary distributed from the storage perspective. ILM framework treats the canary files the same as user files and its file heat is maintained. If the important section within the hot data is growing or data becomes more important, then the hot tier will be plugged with more canary files. If the important section within the hot data is not growing, then canary files plugged will be lower. The file generation, modification, deletion rate is monitored. If the rate exceeds a defined threshold, redistribution is triggered. The quantity of canary files that is sufficient (to be increased or decreased) for a fragment is verified. The quality of canary files that is satisfactory enough for a fragments/hot spot is verified. The canary files are redistributed (i.e., moved between the inner directories or produce new ones) within the hot spot.

In various embodiments, the canary file module 201 causes the computer 101 to track type of I/O requests made and the sensitivity of content. The sensitivity of content information can be keyword, context obtained, that is written to the logical sections. It is implemented via tables or data structures and can be stored in databases/files or in memory.

The hot spot maps from storage perspective can be obtained from the rate of changes happening in the filesystem journals (e.g., number of flushes happening per logically marked segments). The filesystem journals are viewed per fragmented section that could be a directory.

Based on the above tracked info above, in various embodiments, the canary file module 201 causes the computer 101 to start a preconfigured number of files per logical hot spot, where the file contents are generated based on features outlined.

In various embodiments, the canary file module 201 causes the computer 101 to enable an installable policy, to the proposed ILM engine, where it gets auto-triggered based on the reclaim/I/O changes. Lifecycle management (such as creating, deleting etc.) of the canary files are helped when redistribution of the canary files is done within the hot spots.

By way of example, Table 1 below illustrates an example table that shows the files vs. heat per logical section.

TABLE 1

| | | Heat of | Heat of | Heat of |
|---|---|---|---|---|
| | File | Section 1 | Section 2 | Section N |
| File | Heat | (0x12-0x24) | (0x24-0x36) | (0x108-0x120) |
| File-1 | P | X | 2X | X |
| File-2 | 2P | 4X | 3X | 2X |
| . . . | . . . | . . . | . . . | . . . |
| File-N | 3P | X | 3X | X |

By way of example, Table 2 below illustrates an example table that shows files vs. importance per logical section.

TABLE 2

| | Importance of | Importance of | Importance of |
|---|---|---|---|
| | Section 1 | Section 2 | Section N |
| File | (0x12-0x24) | (0x24-0x36) | (0x108-0x120) |
| File-1 | Y | Y | 2Y |
| File-2 | 4Y | Y | Y |
| . . . | . . . | . . . | . . . |
| File-N | Y | 2Y | Y |

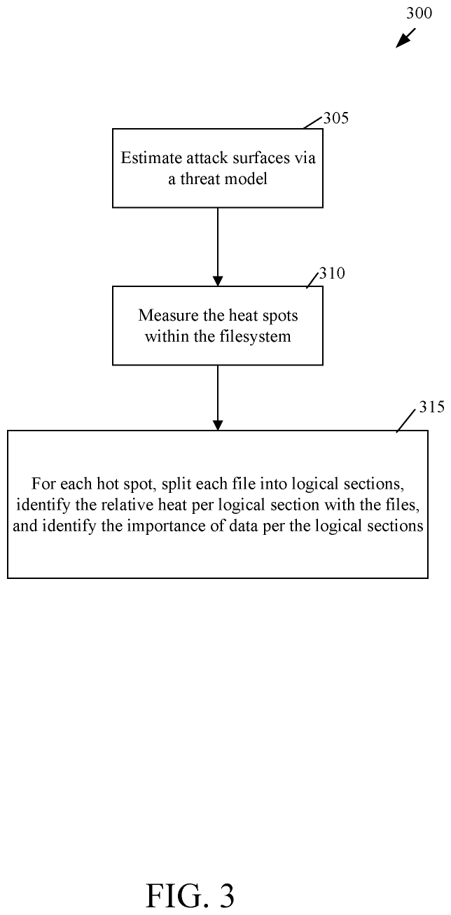

Referring to FIG. 3, a schematic flow chart diagram illustrates one embodiment of a method 300. There is existing software or one can access the audit/access logs in real time of the system to derive the area from which threats or cyber attacks can happen. The output can be imagined as a weighted expression of attack surfaces (e.g., attacks via object protocol: 30%, attacks via portable operating system interface (POSIX): 10%, etc.). At a block 305, the method 300 estimates attack surfaces via a threat model. The threat model is a technique used during a design phase, that helps developers to estimate the threat vectors before developing the product, so that appropriate actions and controls are developed during the design phase itself. The threat model (e.g., spoofing, tampering, repudiation, information disclosure, denial of service, elevation of privilege (STRIDE) method) gives a matrix of attack vectors, risks, and appropriate actions to be taken to mitigate the risks. At a block 310, the method 300 measures the heat spots within a filesystem. Measurement is done based on the access time and the output is a relative weight (e.g., for a period of 24 hours, weights per directory, and weights are reduced if the access time for a particular directory drops). Relative measurements are also used. For example, if directory-1 is most highly accessed directory, then it's ranked-X, and if directory-2 is accessed less than directory-1, then it's ranked-Y, and if directory-3 is accessed less than directory-2, then it's ranked-Z (where X>Y>Z). At a block 315, for each hot spot, each file is split into logical sections, the relative heat per logical section within the files is identified, and importance of data per the logical sections is identified. A hot spot can be a directory or a logical smallest unit for which the access rate can be kept track. The hot spot/logical smallest unit may vary on who wants to implement it. A split can be based on preset block ranges or block sizes set by the user or the implementer. Confidential, importance to the organization, public domain vs. private domain data, authentication method setup to access a particular section (i.e., if multi-factor authentication is setup its weight is high etc.), accessible user position in the organization (CFO vs. normal employee), attached metadata to the file, etc. are all considered in determining a heat value (i.e., hot spot).

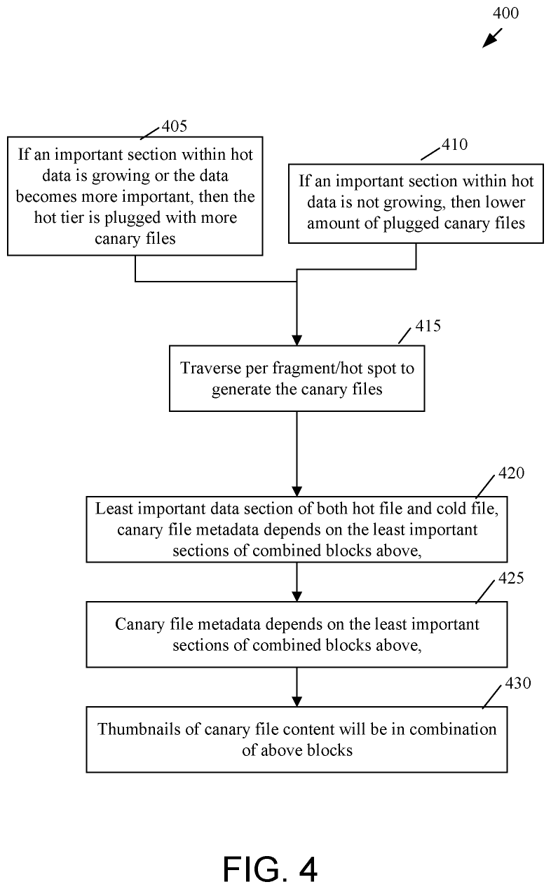

Referring to FIG. 4, a schematic flow chart diagram illustrates one embodiment of a method 400. At block 405, the method 400 plugs the hot tier with more canary files if an important section within hot data is growing or the data becomes more important. At a block 410, the method 400 lowers the amount of plugged canary files if an important section within hot data is not growing. At block 415, the method 400 generates the canary files by traversing per fragment/hot spot. At block 420, the method 400 identifies the least important data section of both hot files and cold files. At block 425, the method 400 identifies canary file metadata as being dependent on the least important sections of combined blocks above. At a block 430, the method 400 combines the above blocks to create thumbnails of canary file content. The individual block ranges that are identified for canary file generation across various files are combined together to generate a single canary or multiple canary files. Apart from data content, the proposed method also prepares the metadata like access time, owner, permissions and thumbnails etc. Thumbnails are translated to metadata generated for video and document files. Thumbnails, similar to Youtube® video screens, show a sense of what the video is for.

Referring to FIG. 5, a schematic flow chart diagram illustrates one embodiment of a method 500. At a block 505, the method 500 generates the canary files by traversing per fragment/hot spot. At a block 510, the method 500 monitors the file generation, modification, deletion rate. If the rate exceeds a predefined threshold, redistribution is triggered. At a block 515, the method 500 verifies if the quantity of canary files are sufficient enough (to be increased or decreased) for a fragment/hot spot. At a block 520, the method 500 verifies if the quality of canary files are satisfactory enough for a fragment/hot spot. At a block 525, the method 500 redistributes the files (i.e., move between inner directories or produce new ones) within the hot spot, if the quantity or quality are not sufficient or satisfactory enough.

The following portion of this paragraph delineates example 1 of the subject matter, disclosed herein. According to example 1, a computer-implemented method for managing file access comprising determining access frequency of files and migrating one or more of the files responsive to the access frequency to improve access to attacks.

The following portion of this paragraph delineates example 2 of the subject matter, disclosed herein. According to example 2, which encompasses example 1, above, the files are canary files.

The following portion of this paragraph delineates example 3 of the subject matter, disclosed herein. According to example 3, which encompasses any of examples 1 or 2, above, tracking includes identifying hot spot maps based on rate of changes happening in filesystem journals of a distributed file system or number of flushes happening per logically marked segments.

The following portion of this paragraph delineates example 4 of the subject matter, disclosed herein. According to example 4, which encompasses any of example 1-3, above, tracking includes tracking per logical section.

The following portion of this paragraph delineates example 5 of the subject matter, disclosed herein. According to example 5, which encompasses example 4, above, a size of the logical section is user configurable.

The following portion of this paragraph delineates example 6 of the subject matter, disclosed herein. According to example 6, which encompasses any of examples 1-5, above, tracking includes tracking of type of input/output (I/O) requests made and sensitivity of accessed content.

The following portion of this paragraph delineates example 7 of the subject matter, disclosed herein. According to example 7, which encompasses example 6, above, the content comprises a keyword or contextual information.

The following portion of this paragraph delineates example 8 of the subject matter, disclosed herein. According to example 8, an apparatus comprising a canary file module that determines access frequency of files and migrates one or more of the files responsive to the access frequency to improve access to attacks. At least a portion of said module comprises one or more of hardware circuits, programmable hardware devices and executable code, the executable code stored on one or more computer readable storage media.

The following portion of this paragraph delineates example 9 of the subject matter, disclosed herein. According to example 9, which encompasses example 8, above, the files are canary files.

The following portion of this paragraph delineates example 10 of the subject matter, disclosed herein. According to example 10, which encompasses any of examples 8 or 9, above, tracking includes identifying hot spot maps based on rate of changes happening in filesystem journals of a distributed file system or number of flushes happening per logically marked segments.

The following portion of this paragraph delineates example 11 of the subject matter, disclosed herein. According to example 11, which encompasses any of examples 8-10, above, tracking includes tracking per logical section.

The following portion of this paragraph delineates example 12 of the subject matter, disclosed herein. According to example 12, which encompasses example 11, above, a size of the logical section is user configurable.

The following portion of this paragraph delineates example 13 of the subject matter, disclosed herein. According to example 13, which encompasses any of examples 8-12, above, tracking includes tracking of type of input/output (I/O) requests made and sensitivity of accessed content.

The following portion of this paragraph delineates example 14 of the subject matter, disclosed herein. According to example 14, which encompasses example 13, above, the content comprises a keyword or contextual information.

The following portion of this paragraph delineates example 15 of the subject matter, disclosed herein. According to example 15, A computer program product for managing file access, the computer program product comprising a computer readable storage medium having program instructions embodied therewith, the program instructions executable by a device to cause the device to determine access frequency of files and migrate one or more of the files responsive to the access frequency to improve access to attacks.

The following portion of this paragraph delineates example 16 of the subject matter, disclosed herein. According to example 16, which encompasses example 15, above, the files are canary files.

The following portion of this paragraph delineates example 17 of the subject matter, disclosed herein. According to example 17, which encompasses any of examples 15 or 16, above, tracking includes identifying hot spot maps based on rate of changes happening in filesystem journals of a distributed file system or number of flushes happening per logically marked segments.

The following portion of this paragraph delineates example 18 of the subject matter, disclosed herein. According to example 18, which encompasses any of examples 15-17, above, tracking includes tracking per logical section.

The following portion of this paragraph delineates example 19 of the subject matter, disclosed herein. According to example 19, which encompasses example 18, above, a size of the logical section is user configurable.

The following portion of this paragraph delineates example 20 of the subject matter, disclosed herein. According to example 20, which encompasses any of examples 15-19, above, wherein tracking includes tracking of type of I/O requests made and sensitivity of accessed content, the content comprises a keyword or contextual information.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing canary files in a filesystem comprising:
monitoring, by a processor set, filesystem activity data associated with accessing files in the filesystem to identify an attack surface of the filesystem based on the monitored filesystem activity data;
collecting, by the processor set, filesystem journal data and generating, from the filesystem journal data, hot spot maps identifying filesystem locations associated with elevated rates of change;
for a file associated with a hot spot identified in the hot spot maps:
splitting, by the processor set, the file into logical sections;
monitoring, by the processor set for each logical section, activity data for the logical section to determine at least one selected from a group consisting of: an access frequency value for the logical section and a data importance value of the logical section; and
storing in one or more data structures by the processor set for each logical section, at least one selected from the group consisting of: the access frequency value and the data importance value;
selecting, by the processor set, a least-important logical section of the file based on at least one selected from the group consisting of: the stored access frequency value and the stored data importance value;
generating, by the processor set, one or more canary files by assembling file content from the selected least-important logical section and assigning metadata to the one or more canary files that emulates metadata of files in the hot spot; and
storing, by the processor set, the one or more canary files within a directory corresponding to the hot spot.

2. The computer-implemented method of claim 1, wherein identifying the attack surface of the filesystem comprises determining at least one metric selected from the group consisting of a rate of I/O requests, types of I/O requests, authentication success rates, and authentication failure rates.

3. The computer-implemented method of claim 1, wherein generating the hot spot maps comprises identifying filesystem locations exhibiting elevated rates of journal flush operations relative to other filesystem locations.

4. The computer-implemented method of claim 1, wherein splitting the file into logical sections comprises dividing the file into fixed-size block ranges, a size of the block ranges being user configurable.

5. The computer-implemented method of claim 1, wherein the data importance value of a logical section is determined based on at least one selected from the group consisting of keyword content, contextual metadata, access control requirements, and user privilege levels associated with access to the logical section.

6. The computer-implemented method of claim 1, wherein generating the one or more canary files comprises assembling file content from least-important logical sections of a plurality of files associated with the hot spot.

7. The computer-implemented method of claim 1, further comprising monitoring rates of file creation, modification, and deletion within the hot spot and triggering redistribution of the one or more canary files when a monitored rate exceeds a predefined threshold.

8. The computer-implemented method of claim 1, further comprising distributing canary files in one or more directories corresponding to hot spots such that the canary files are distributed across different storage tiers based on file heat.

9. The computer-implemented method of claim 8, wherein the file heat of the canary files are dynamically adjusted to reduce migration of the canary files to a cold storage tier.

10. A computer system comprising:
a processor set;
one or more computer-readable storage media; and
program instruction stored on the one or more computer-readable storage media to cause the processor set to perform operations comprising:
monitoring filesystem activity data associated with accessing files in the filesystem to identify an attack surface of the filesystem based on the monitored filesystem activity data;
collecting filesystem journal data and generating, from the filesystem journal data, hot spot maps identifying filesystem locations associated with elevated rates of change;
for a file associated with a hot spot identified in the hot spot maps:
splitting the file into logical sections;
monitoring, for each logical section, activity data for the logical section to determine at least one selected from a group consisting of: an access frequency value for the logical section and a data importance value of the logical section; and
storing, for each logical section in one or more data structures, at least one selected from the group consisting of: the access frequency value and the data importance value;
selecting a least-important logical section of the file based on at least one selected from the group consisting of: the stored access frequency value and the stored data importance value;
generating one or more canary files by assembling file content from the selected least-important logical section and assigning metadata to the one or more canary files that emulates metadata of files in the hot spot; and
storing the one or more canary files within a directory corresponding to the hot spot.

11. The computer system of claim 10, wherein identifying the attack surface of the filesystem comprises determining at least one metric selected from the group consisting of a rate of I/O requests, types of I/O requests, authentication success rates, and authentication failure rates.

12. The computer system of claim 10, wherein generating the hot spot maps comprises identifying filesystem locations exhibiting elevated rates of journal flush operations relative to other filesystem locations.

13. The computer system of claim 10, wherein splitting the file into logical sections comprises dividing the file into fixed-size block ranges, a size of the block ranges being user configurable.

14. The computer system of claim 10, wherein the data importance value of a logical section is determined based on at least one selected from the group consisting of keyword content, contextual metadata, access control requirements, and user privilege levels associated with access to the logical section.

15. The computer system of claim 10, wherein generating the one or more canary files comprises assembling file content from least-important logical sections of a plurality of files associated with the hot spot.

16. The computer system of claim 10, further comprising monitoring rates of file creation, modification, and deletion within the hot spot and triggering redistribution of the one or more canary files when a monitored rate exceeds a predefined threshold.

17. A computer program product comprising:
one or more computer-readable storage media; and
program instructions stored on the one or more computer-readable storage media to perform operations comprising:
monitoring filesystem activity data associated with accessing files in the filesystem to identify an attack surface of the filesystem based on the monitored filesystem activity data;
collecting filesystem journal data and generating, from the filesystem journal data, hot spot maps identifying filesystem locations associated with elevated rates of change;
for a file associated with a hot spot identified in the hot spot maps:
splitting the file into logical sections;
monitoring, for each logical section, activity data for the logical section to determine at least one selected from a group consisting of: an access frequency value for the logical section and a data importance value of the logical section; and
storing, for each logical section in one or more data structures, at least one selected from the group consisting of: the access frequency value and the data importance value;
selecting a least-important logical section of the file based on at least one selected from the group consisting of: the stored access frequency value and the stored data importance value;
generating one or more canary files by assembling file content from the selected least-important logical section and assigning metadata to the one or more canary files that emulates metadata of files in the hot spot; and
storing the one or more canary files within a directory corresponding to the hot spot.

18. The computer program product of claim 17, wherein splitting the file into logical sections comprises dividing the file into fixed-size block ranges, a size of the block ranges being user configurable.

19. The computer program product of claim 17, wherein the data importance value of a logical section is determined based on at least one selected from the group consisting of keyword content, contextual metadata, access control requirements, and user privilege levels associated with access to the logical section.

20. The computer program product of claim 17, wherein generating the one or more canary files further comprises assembling file content from least-important logical sections of a plurality of files associated with the hot spot.
